(19) United States
(12) Patent Application Publication
(10) Pub. No.: US 2024/0181646 A1
(43) Pub. Date: Jun. 6, 2024

(54) Method of Calibrating Manipulator, Control System and Robot System

(71) Applicant: ABB Schweiz AG, Baden (CH)

(72) Inventors: Sven Hanssen, Västerås (SE); Hans Andersson, Västerås (SE); Johan Noren, Västerås (SE)

(21) Appl. No.: 18/556,276

(22) PCT Filed: Apr. 29, 2021
(86) PCT No.: PCT/EP2021/061262

§ 371 Date: Oct. 19, 2023

(51) Int. Cl. B25J 9/16; B25J 13/08

(52) U.S. Cl. CPC B25J 9/1692; B25J 9/1682; B25J 13/085

(57) ABSTRACT

A method of calibrating a manipulator of an industrial robot, the method including providing a primary manipulator having one or more primary joints and a primary mounting interface; providing a secondary manipulator having one or more secondary joints and a secondary mounting interface, where the primary mounting interface is substantially rigidly connected to the secondary mounting interface; providing a load sensor between the primary mounting interface and the secondary mounting interface, the load sensor being configured to provide load data indicative of loads between the primary mounting interface and the secondary mounting interface; controlling the primary manipulator to adopt at least one calibration state; for each calibration state, recording a primary joint position of at least one primary joint; and calibrating the secondary manipulator based on the at least one recorded primary joint position; wherein the primary manipulator is controlled to adopt the at least one calibration state based on the load data; and/or wherein the calibration of the secondary manipulator is additionally made based on the load data.

### TECHNICAL FIELD

The present disclosure generally relates to calibration of robotic manipulators. In particular, a method of calibrating a manipulator of an industrial robot, a control system for calibrating a manipulator of an industrial robot, and a robot system comprising a control system, are provided.

### BACKGROUND

A manipulator of an industrial robot may comprise a plurality of joints and a plurality of intermediate links. To be able to determine the position of the manipulator, each joint is usually provided with an angle measuring device in the form of an encoder or a resolver indicating the position of the joint relative to a zero position. By reading the joint positions, a pose (position and orientation) of a tool center point, TCP, of the manipulator can be determined.

Before the manipulator can be used it must be calibrated, e.g. calibrating each of the angle measuring devices with reference to the zero position. Calibrating the manipulator can be a tedious and difficult operation, but is also very important. The manipulator may be calibrated at its manufacturing site before it is delivered. Such calibrations however typically require expensive measurement equipment, such as a laser tracking system. For this reason, field calibration, e.g. at a production site where the manipulator operates, is less common. Instead, the manipulator is often returned to the manufacturer for calibration.

TW 202015868 A discloses a method for calibrating the TCP of a robot arm. The method detects the gravity and torque of a tool and the contact force and contact torque of the TCP with a force sensor of the robot arm. The contact force and contact torque of the TCP respectively minus the gravity and torque of the tool are used to calculate the tension arm of a net contact force. The tension arm determines the coordinate of the TCP to automatically calibrate the TCP of the robot arm.

### SUMMARY

One object of the present disclosure is to provide an improved method of calibrating a manipulator of an industrial robot.

A further object of the present disclosure is to provide a method of calibrating a manipulator of an industrial robot, which method provides an accurate calibration.

A still further object of the present disclosure is to provide a cost-efficient method of calibrating a manipulator of an industrial robot.

A still further object of the present disclosure is to provide a method of calibrating a manipulator of an industrial robot, which method can easily be carried out in the field.

A still further object of the present disclosure is to provide a method of calibrating a manipulator of an industrial robot, which method solves several or all of the foregoing objects in combination.

A still further object of the present disclosure is to provide a control system for calibrating a manipulator, which control system solves one, several or all of the foregoing objects.

A still further object of the present disclosure is to provide a robot system comprising a control system, which robot system solves one, several or all of the foregoing objects.

According to a first aspect, there is provided a method of calibrating a manipulator of an industrial robot, the method comprising providing a primary manipulator having one or more primary joints and a primary mounting interface; providing a secondary manipulator having one or more secondary joints and a secondary mounting interface, where the primary mounting interface is substantially rigidly connected to, or rigidly connected to, the secondary mounting interface; providing a load sensor between the primary mounting interface and the secondary mounting interface, the load sensor being configured to provide load data indicative of loads between the primary mounting interface and the secondary mounting interface; controlling the primary manipulator to adopt at least one calibration state; for each calibration state, recording a primary joint position of at least one primary joint; and calibrating the secondary manipulator based on the at least one recorded primary joint position; wherein the primary manipulator is controlled to adopt the at least one calibration state based on the load data; and/or wherein the calibration of the secondary manipulator is additionally made based on the load data.

In the method, the primary manipulator is used as a measurement manipulator. If the primary manipulator is well calibrated, the primary manipulator can be used as a measurement device for various measurements in its surroundings. However, if the primary manipulator is subjected to external loads, the accuracy of such measurements will be reduced if the external loads are not taken into account.

By means of the load data from the load sensor, information regarding external loads acting on the primary manipulator is obtained. By taking these external loads into account, and/or by moving the primary manipulator to one or more manipulator poses where such external loads are reduced or eliminated, the calibration of the secondary manipulator is improved.

The load sensor may be rigidly connected to each of the primary mounting interface and the secondary mounting interface, for example by means of one or more fasteners, such as screws. A positioning of the load sensor between the mounting interfaces is relatively straightforward and can therefore be carried out by less experienced users. The positioning of the load sensor between the mounting interfaces provides more accurate values of loads acting between the mounting interfaces, in comparison with a calculation of such loads based on a load sensor in one of the primary joints of primary manipulator. Thus, the positioning of the load sensor between the mounting interfaces enables an accurate control of the loads between the mounting interfaces, such as a zero load.

The method may further comprise determining a primary TCP (tool center point) pose of the primary manipulator based on the at least one primary joint position, and optionally based on the load data, by means of forward kinematics for each calibration state. Since the primary mounting interface is rigidly connected to the secondary mounting interface, there is a fixed and known relationship between the primary TCP pose and a secondary TCP pose of the secondary manipulator. A TCP pose defines both a position and an orientation of the TCP. The primary TCP position and the secondary TCP position may coincide or may be offset from each other. The primary TCP orientation and the secondary TCP orientation may or may not be angled relative to each other. In one example, the primary TCP pose and the secondary TCP pose coincide. In case a load as determined by the load sensor acts on the primary manipulator, a corresponding load acts on the secondary manipulator.

The method may further comprise recording a recorded secondary joint position of at least one secondary joint for each calibration state. The method may further comprise calculating a calculated secondary joint position of at least one secondary joint based on the secondary TCP pose, and optionally based on the load data, by means of inverse kinematics for each calibration state. The method may further comprise calibrating the secondary manipulator based on the at least one recorded secondary joint position and the at least one calculated secondary joint position for each calibration state. In this way, the secondary manipulator is calibrated based on the at least one recorded primary joint position.

According to one variant, the secondary manipulator is controlled with a reduced stiffness throughout the method. In this way, the secondary manipulator is made compliant and can be moved by the primary manipulator to a plurality of different manipulator poses. Even though the primary manipulator and the secondary manipulator may be stationary in each calibration state, the primary manipulator may still exert a force and/or a torque on the secondary manipulator, or vice versa. In this case, internal friction of the manipulators may contribute to prevent the manipulators from moving. If forces and torques are transferred between the manipulators, the manipulators will deflect. If such deflection is not taken into consideration, the calibration will be inaccurate.

According to a further variant, the secondary manipulator is controlled with a high stiffness throughout the method. The secondary manipulator thereby remains substantially stationary and cannot be substantially moved by the primary manipulator. In this case, the primary manipulator may be controlled to exert a first load on the secondary manipulator in a first calibration state, and to exert a second load, different from the first load, on the secondary manipulator in a second calibration state. The load data for each calibration state may then be used together with the at least one recorded primary joint position for the calibration of the secondary manipulator.

In addition to the primary manipulator and the secondary manipulator, the method can be carried out by only additionally providing the load sensor. Thus, no expensive and sensitive measurement equipment is required. By using the primary manipulator as a measurement manipulator according to the method, the process is available in environments with two or more robotic manipulators. Furthermore, since load sensors are relatively cheap and since the method does not require a load sensor for each manipulator, the method is cost-efficient.

Each joint may be either rotational or translational. In addition to the at least one primary joint and the at least one secondary joint, the primary manipulator and the secondary manipulator may comprise at least two primary links and at least two secondary links, respectively. Each of the primary manipulator and the secondary manipulator may be a robotic arm.

The method may comprise controlling the primary manipulator to adopt one calibration state or a plurality of unique calibration states. Alternatively, or in addition, the method may comprise recording a primary joint position of each primary joint. Each mounting interface may for example be a tool flange.

As used herein, loads may include forces and/or torques. Furthermore, a manipulator pose defines a position of each joint of the manipulator. In some manipulators, a single TCP position can be obtained with different manipulator poses. Furthermore, manipulators with more than six axes can obtain a single TCP pose with different manipulator poses.

The method according to the first aspect may use a control system of any type according to the second aspect and/or robot system of any type according to the third aspect.

The method may comprise controlling the primary manipulator to adopt a plurality of calibration states. In this case, each calibration state may be a unique manipulator pose of the primary manipulator.

In case the primary manipulator is controlled to adopt the at least one calibration state based on the load data, the load, as measured by the load sensor, may be minimized or locally minimized in each manipulator pose. In this way, deformations of the primary manipulator and the secondary manipulator can be reduced or eliminated. The load data can be used to identify any external loads acting on the primary manipulator and to move the primary manipulator to a manipulator pose where the primary manipulator is in a more relaxed state. In other words, the primary manipulator can be controlled to a manipulator pose where the primary manipulator is less deformed, or not deformed. By reducing the deformation of the primary manipulator, an estimation of the position of the primary manipulator, such as a pose of the primary TCP, can be improved.

In this variant, the load data is used when controlling the primary manipulator to adopt the at least one calibration state, but does not have to be considered for the calibration. For example, the forward kinematics for calculating the primary TCP pose can be performed purely based on the one or more primary joint positions and the inverse kinematics for calculating the calculated secondary joint positions can be performed purely based on the secondary TCP pose. The minimization may comprise, for each calibration state, controlling the primary manipulator such that the load is below a threshold value.

As an alternative example, the method may comprise controlling the primary manipulator to adopt a plurality of arbitrary calibration states, with one or several manipulator poses. In this case, the load data does not have to be considered when controlling the primary manipulator to adopt the respective calibration state. However, the load data is then used together with the at least one recorded primary joint position for the calibration of the secondary manipulator.

In case each calibration state is a unique manipulator pose of the primary manipulator, the method may further comprise moving the primary manipulator to a plurality of calibration states while moving the secondary manipulator by the primary manipulator by means of lead-through. This variant may thus further comprise controlling the secondary manipulator in a lead-through mode. In such lead-through mode, the stiffness of the secondary manipulator is reduced and the secondary manipulator is thereby made compliant. Although the secondary manipulator is in lead-through mode, loads may be transferred between the primary manipulator and the secondary manipulator, e.g. due to internal friction of the manipulators.

The load sensor may be configured to provide load data indicative of forces and/or torques. The load sensor may thus be a force sensor, a torque sensor or a force and torque sensor, such as a six axis (three forces and three torques) sensor.

According to a second aspect, there is provided a control system for calibrating a manipulator of an industrial robot, the control system comprising at least one data processing device and at least one memory having at least one computer program stored thereon, the at least one computer program comprising program code which, when executed by the at least one data processing device, causes the at least one data processing device to perform the steps of receiving load data from a load sensor indicative of loads, the load sensor being positioned between a primary mounting interface of a primary manipulator having one or more primary joints and a secondary mounting interface of a secondary manipulator having one or more secondary joints, where the primary mounting interface is substantially rigidly connected to, or rigidly connected to, the secondary mounting interface; controlling the primary manipulator to adopt at least one calibration state; for each calibration state, recording a primary joint position of at least one primary joint; and calibrating the secondary manipulator based on the at least one recorded primary joint position; wherein the primary manipulator is controlled to adopt the at least one calibration state based on the load data; and/or wherein the calibration of the secondary manipulator is additionally made based on the load data.

The at least one computer program may comprise program code which, when executed by the at least one data processing device, causes the at least one data processing device to perform, or command performance or, several or all of the steps described in the first aspect.

The at least one computer program may comprise program code which, when executed by the at least one data processing device, causes the at least one data processing device to perform the steps of controlling the primary manipulator to adopt a plurality of calibration states. In this case, each calibration state may be a unique manipulator pose of the primary manipulator.

In case the at least one computer program comprises program code which, when executed by the at least one data processing device, causes the at least one data processing device to perform the step of controlling the primary manipulator to adopt the at least one calibration state based on the load data, the load, as measured by the load sensor, may be minimized or locally minimized in each manipulator pose. Alternatively, or in addition, the at least one computer program may comprise program code which, when executed by the at least one data processing device, causes the at least one data processing device to perform the steps of controlling the secondary manipulator in a lead-through mode; and controlling the primary manipulator to move to a plurality of calibration states while controlling the secondary manipulator in the lead-through mode.

According to a third aspect, there is provided a robot system comprising the primary manipulator, the secondary manipulator, the load sensor and a control system according to the second aspect. The primary manipulator, the secondary manipulator and the load sensor may be of any type described in connection with the first and second aspects.

The robot system may comprise a first industrial robot and a second industrial robot. In this case, the first industrial robot may comprise the primary manipulator and the second industrial robot may comprise the secondary manipulator. The first industrial robot and the second industrial robot may be of the same type or of different types (e.g. with different ratings). Moreover, a common control system may be used to control both the primary manipulator and the secondary manipulator. This common control system may be a first control system of the first industrial robot, a second control system of the second industrial robot or a separate control system.

Alternatively, the robot system may comprise a single industrial robot having both the primary manipulator and the secondary manipulator. Such industrial robot may be a dual-arm robot. If one arm needs to be calibrated, the other arm can be used as a measurement device. The method and the control system according to the present disclosure greatly facilitate replacement of a first arm of a dual-arm robot since a second arm of the dual-arm robot can be used to calibrate a third arm replacing the first arm. The load sensor may be detachably attached to each of the primary mounting interface and the secondary mounting interface.

The robot system may further comprise a connection member comprising the load sensor and configured to be rigidly connected to each of the primary mounting interface and the secondary mounting interface. The connection member may be rigid.

The load sensor may be configured to provide load data indicative of forces and/or torques.

### BRIEF DESCRIPTION OF THE DRAWINGS

Further details, advantages and aspects of the present disclosure will become apparent from the following description taken in conjunction with the drawings, wherein:

FIG. 1: schematically represents one example of a robot system comprising a first industrial robot having a primary manipulator and a second industrial robot having a secondary manipulator when the primary manipulator is in one example of a calibration state;

FIG. 2: schematically represents the robot system when the primary manipulator is in a further example of a calibration state; and

FIG. 3: schematically represents the robot system when the primary manipulator is in a further example of a calibration state; and

FIG. 4: schematically represents a further example of a robot system comprising a third industrial robot having a primary manipulator and a secondary manipulator when the primary manipulator is in one example of a calibration state.

### DETAILED DESCRIPTION

In the following, a method of calibrating a manipulator of an industrial robot, a control system for calibrating a manipulator of an industrial robot, and a robot system comprising a control system, will be described. The same or similar reference numerals will be used to denote the same or similar structural features.

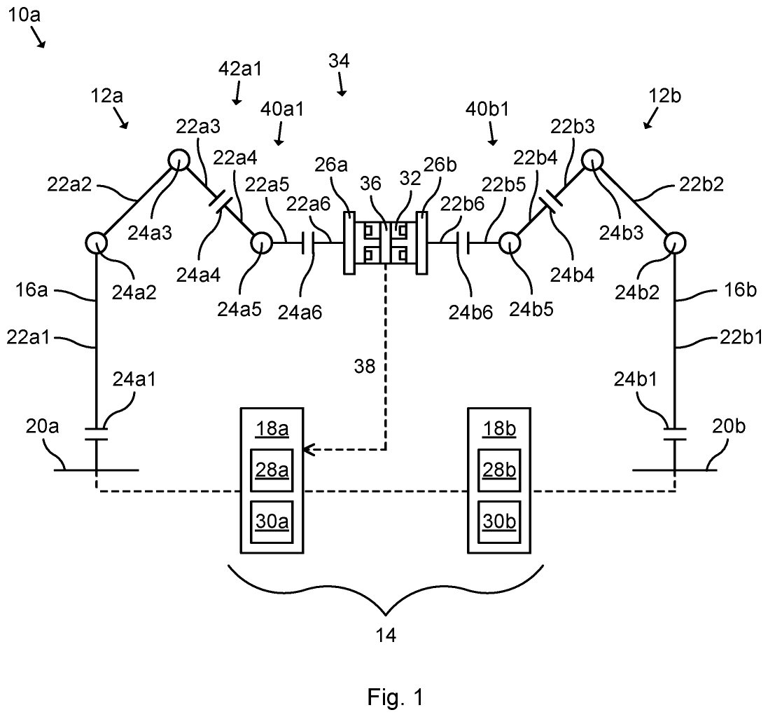

FIG. 1 schematically represents one example of a robot system 10a. The robot system 10a comprises a first industrial robot 12a, a second industrial robot 12b and a control system 14. Each of the first industrial robot 12a and the second industrial robot 12b may for example be a welding robot at a common production site.

The first industrial robot 12a comprises a primary manipulator 16a and a primary robot controller 18a. The primary manipulator 16a of this specific example is a serial manipulator comprising a primary base 20a, a primary first link 22a1 rotatable relative to the primary base 20a at a primary first joint 24a1, a primary second link 22a2 rotatable relative to the primary first link 22a1 at a primary second joint 24a2, a primary third link 22a3 rotatable relative to the primary second link 22a2 at a primary third joint 24a3, a primary fourth link 22a4 rotatable relative to the primary third link 22a3 at a primary fourth joint 24a4, a primary fifth link 22a5 rotatable relative to the primary fourth link 22a4 at a primary fifth joint 24a5, and a primary sixth link 22a6 rotatable relative to the primary fifth link 22a5 at a primary sixth joint 24a6. One, several or all of the primary links 22a1-22a6 may also be referred to with reference numeral “22a”. One, several or all of the primary joints 24a1-24a6 may also be referred to with reference numeral “24a”. The primary manipulator 16a further comprises a plurality of primary angle measuring devices (not shown) for reading the positions of the primary joints 24a.

The second industrial robot 12b comprises a secondary manipulator 16b and a secondary robot controller 18b. The secondary manipulator 16b of this specific example is a serial manipulator comprising a secondary base 20b, a secondary first link 22b1 rotatable relative to the secondary base 20b at a secondary first joint 24b1, a secondary second link 22b2 rotatable relative to the secondary first link 22b1 at a secondary second joint 24b2, a secondary third link 22b3 rotatable relative to the secondary second link 22b2 at a secondary third joint 24b3, a secondary fourth link 22b4 rotatable relative to the secondary third link 22b3 at a secondary fourth joint 24b4, a secondary fifth link 22b5 rotatable relative to the secondary fourth link 22b4 at a secondary fifth joint 24b5, and a secondary sixth link 22b6 rotatable relative to the secondary fifth link 22b5 at a secondary sixth joint 24b6. One, several or all of the secondary links 22b1-22b6 may also be referred to with reference numeral “22b”. One, several or all of the secondary joints 24b1-24b6 may also be referred to with reference numeral “24b”. The secondary manipulator 16b further comprises a plurality of secondary angle measuring devices (not shown) for reading the positions of the secondary joints 24b.

The manipulators 16a and 16b in FIG. 1 are however merely two of many examples. One or both manipulators 16a and 16b may for example also comprise one or more translational joints.

The primary manipulator 16a further comprises a primary mounting interface 26a, here exemplified as a primary tool flange. The primary mounting interface 26a is in this example fixed to the primary sixth link 22a6. A primary tool center point, TCP, is defined in relation to the primary mounting interface 26a.

The secondary manipulator 16b further comprises a secondary mounting interface 26b, here exemplified as a secondary tool flange. The secondary mounting interface 26b is in this example fixed to the secondary sixth link 22b6. A secondary TCP is defined in relation to the secondary mounting interface 26b.

The control system 14 of this example comprises the primary robot controller 18a and the secondary robot controller 18b. The control system 14 in FIG. 1 is however merely one of many examples. The primary robot controller 18a of this example comprises a primary data processing device 28a and a primary memory 30a. The primary memory 30a comprises a computer program containing program code, which when executed by the primary data processing device 28a, causes the primary data processing device 28a to execute, or command execution of, various steps as described herein. The primary robot controller 18a is in signal communication with the primary manipulator 16a and the secondary robot controller 18b.

The secondary robot controller 18b of this example comprises a secondary data processing device 28b and a secondary memory 30b. The secondary memory 30b comprises a computer program containing program code, which when executed by the secondary data processing device 28b, causes the secondary data processing device 28b to execute, or command execution of, various steps as described herein.

The robot system 10a of this example further comprises a connection member 32. The connection member 32 is a rigid piece that is rigidly connected to each of the primary mounting interface 26a and the secondary mounting interface 26b, here by means of screws (not denoted). The connection member 32 can be attached to, and detached from, the mounting interfaces 26a and 26b by a human user. When the primary mounting interface 26a is fixed to the secondary mounting interface 26b, the primary manipulator 16a and the secondary manipulator 16b form a common kinematic chain 34. The primary TCP and the secondary TCP are here coinciding in a common point. The offset between the primary TCP and the secondary TCP may alternatively be known.

The robot system 10a further comprises a load sensor 36. The load sensor 36 is arranged in the connection member 32. The load sensor 36 is thereby positioned between the mounting interfaces 26a and 26b.

The load sensor 36 is configured to measure loads and to issue load data 38 indicative of the measured loads. The load sensor 36 is in signal communication with the control system 14, here with the primary robot controller 18a. The load sensor 36 may be a commercially available load sensor, and is here exemplified as a six axis (three forces and three torques) load sensor.

In FIG. 1, the primary manipulator 16a is controlled by the primary robot controller 18a to be positioned in a first primary manipulator pose 40a1. The secondary manipulator 16b is controlled by the secondary robot controller 18b in a lead-through mode. Since the manipulators 16a and 16b are connected, the secondary manipulator 16b adopts a first secondary manipulator pose 40b1 when the primary manipulator 16a adopts the first primary manipulator pose 40a1. Based on the load data 38, the primary robot controller 18a has positioned the primary manipulator 16a such that no forces and no torques are transferred between the manipulators 16a and 16b. If the connection member 32 in theory was cut in half to separate the manipulators 16a and 16b, the manipulators 16a and 16b would thereby not move. The state of the primary manipulator 16a when the primary manipulator 16a adopts the first primary manipulator pose 40a1 and when no forces or torques are transferred between the manipulators 16a and 16b constitutes a first calibration state 42a1 of the primary manipulator 16a. As an alternative to lead-through control of the secondary manipulator 16b, the secondary manipulator 16b may be controlled to move based on the load data 38.

In this example, the primary manipulator 16a is well calibrated and the secondary manipulator 16b is not calibrated. In order to calibrate the secondary manipulator 16b, the primary joint positions of the primary joints 24a are recorded by the primary robot controller 18a when the primary manipulator 16a is in the first calibration state 42a1. The primary robot controller 18a then calculates a primary TCP pose based on the primary joint positions by means of forward kinematics using a model of the primary manipulator 16a. The primary robot controller 18a then communicates the primary TCP pose to the secondary robot controller 18b. Since the relationship between the primary TCP pose and the secondary TCP pose is known, the secondary robot controller 18b can determine the secondary TCP pose based on the primary TCP pose. In this example however, the primary TCP pose and the secondary TCP pose coincide when the primary mounting interface 26a is fixed to the secondary mounting interface 26b. The secondary robot controller 18b then calculates calculated secondary joint positions of the secondary joints 24b based on the secondary TCP pose by means of inverse kinematics using a model of the secondary manipulator 16b. The secondary manipulator 16b of the second industrial robot 12b can then be calibrated based on the calculated secondary joint positions and recorded secondary joint positions of the secondary joints 24b as recorded by the secondary robot controller 18b in the first calibration state 42a1. In case the secondary manipulator 16b would comprise more than six degrees of freedom, one, several or all of the recorded secondary joint positions may additionally be considered for calculating the calculated secondary joint positions based on the secondary TCP pose.

By controlling the primary manipulator 16a such that no, or very small, forces and torques are transferred between the manipulators 16a and 16b, deflections of the manipulators 16a and 16b are eliminated or reduced. This improves the accuracy of the calibration.

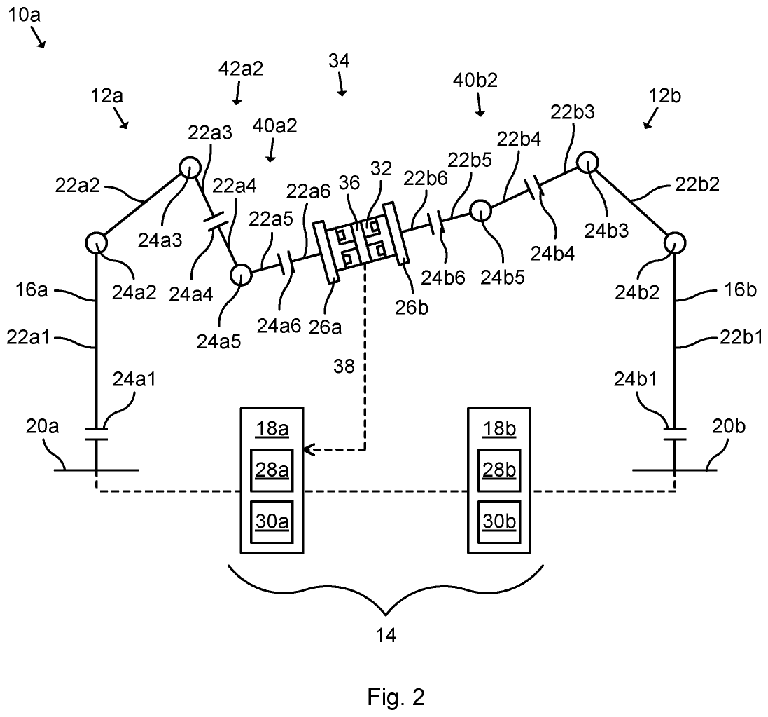

FIG. 2 schematically represents the robot system 10a when the primary manipulator 16a is in a second calibration state 42a2. The second calibration state 42a2 differs from the first calibration state 42a1 in that the primary manipulator 16a is positioned in a second primary manipulator pose 40a2. As a consequence, the secondary manipulator 16b, which is controlled in lead-through mode, follows the primary manipulator 16a and becomes positioned in a second secondary manipulator pose 40b2. Also in the second calibration state 42a2, no forces or torques are transferred between the manipulators 16a and 16b. The second primary manipulator pose 40a2 may be selected so as to maximize movements of the joints 24a and 24b.

The control system 14 then calculates calculated secondary joint positions and records recorded joint positions of the secondary joints 24b for the second calibration state 42a2 in the same way as described in connection with FIG. 1. Several sets of recorded secondary joint positions and corresponding recorded joint positions can then be used to further improve the calibration, e.g. one set for each calibration state 42a1 and 42a2.

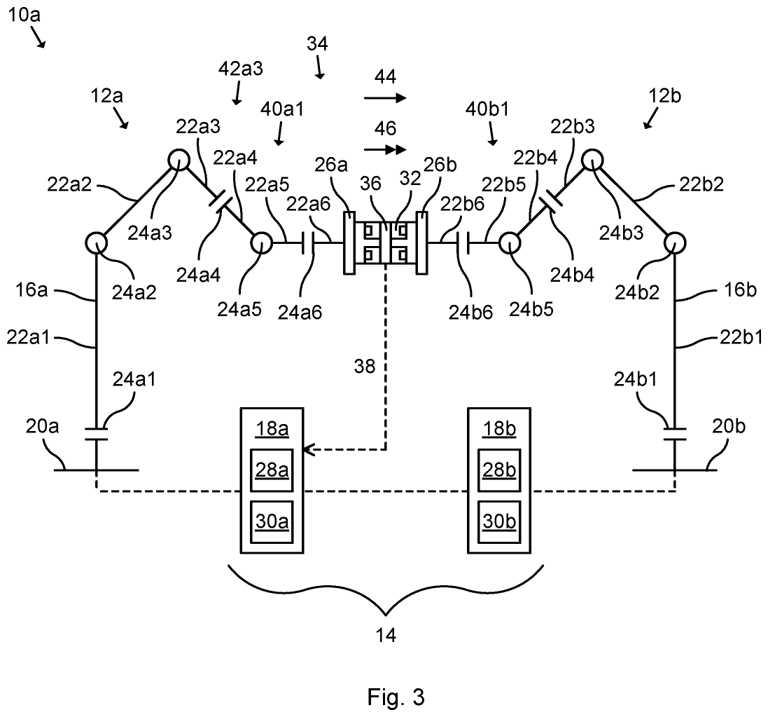

FIG. 3 schematically represents the robot system 10a when the primary manipulator 16a is in a third calibration state 42a3. The third calibration state 42a3 differs from the first calibration state 42a1 in that the primary manipulator 16a exerts a force 44 and a torque 46 on the secondary manipulator 16b. To this end, the primary robot controller 18a controls the primary manipulator 16a to exert a predetermined force 44 and a predetermined torque 46 based on the load data 38. The secondary manipulator 16b is here not controlled in lead-through, but is instead controlled with a high stiffness. In FIG. 3, the primary manipulator 16a is in the first primary manipulator pose 40a1 and the secondary manipulator 16b is in the first secondary manipulator pose 40b1.

In order to calibrate the secondary manipulator 16b, the primary joint positions of the primary joints 24a and the load data 38 are recorded by the primary robot controller 18a when the primary manipulator 16a is in the third calibration state 42a3. The primary robot controller 18a then calculates a primary TCP pose based on the primary joint positions and the load data 38 by means of forward kinematics. In case the load data 38 should not be considered for the calculation of the primary TCP pose when the primary manipulator 16a exerts the force 44 and the torque 46 on the secondary manipulator 16b, the primary TCP pose would be erroneous due to the deflection of the primary manipulator 16a. The primary robot controller 18a then communicates the primary TCP pose and the load data 38 to the secondary robot controller 18b. Since the relationship between the primary TCP pose and the secondary TCP pose is known, the secondary robot controller 18b can determine the secondary TCP pose based on the primary TCP pose. The secondary robot controller 18b then calculates calculated secondary joint positions of the secondary joints 24b based on the secondary TCP pose and the load data 38 by means of inverse kinematics. To this end, the force 44 and the torque 46 are also modelled. The secondary manipulator 16b can then be calibrated based on the calculated secondary joint positions and recorded secondary joint positions of the secondary joints 24b as recorded by the secondary robot controller 18b for the third calibration state 42a3. Several sets of recorded secondary joint positions corresponding recorded joint positions can then be used to further improve the calibration, e.g. one set for each calibration state 42a1, 42a2 and 42a3.

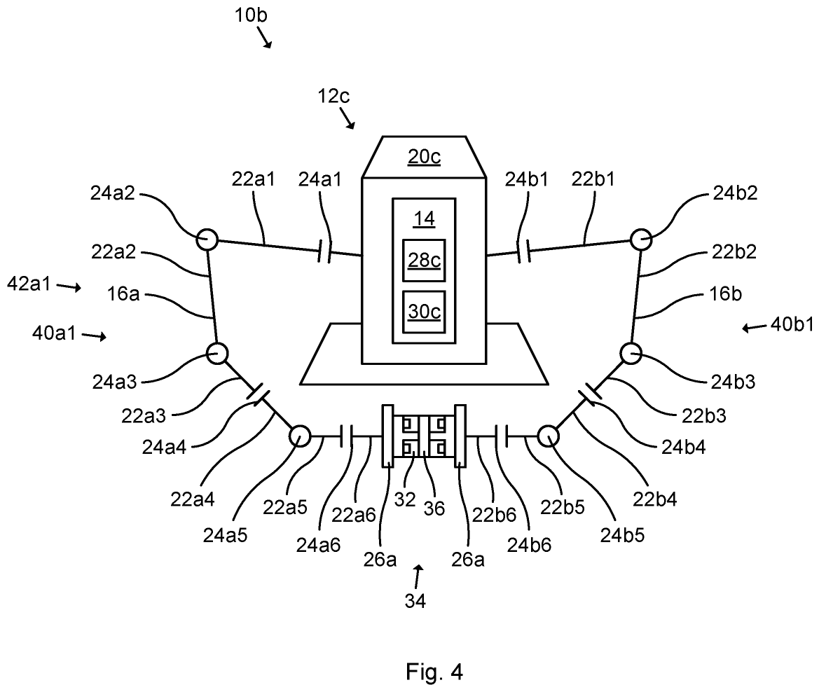

FIG. 4 schematically represents a further example of a robot system 10b. The robot system 10b comprises a single industrial robot 12c. The industrial robot 12c comprises a primary manipulator 16a and a secondary manipulator 16b. The industrial robot 12c further comprises a base 20c from which the primary manipulator 16a and the secondary manipulator 16b extend. The industrial robot 12c is a dual-arm robot, such as the YuMi sold by ABB. The control system 14 of the industrial robot 12c is here constituted by a single robot controller comprising a data processing device 28c and a memory 30c. The principles of calibrating the industrial robot 12c correspond to the principles of calibrating the industrial robot 12b.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A method of calibrating a manipulator of an industrial robot, the method comprising:
providing a primary manipulator having one or more primary joints and a primary mounting interface;
providing a secondary manipulator having one or more secondary joints and a secondary mounting interface, where the primary mounting interface is substantially rigidly connected to the secondary mounting interface;
providing a load sensor between the primary mounting interface and the secondary mounting interface, the load sensor being configured to provide load data indicative of loads between the primary mounting interface and the secondary mounting interface;
controlling the primary manipulator to adopt at least one calibration state;
for each calibration state, recording a primary joint position of at least one primary joint; and
calibrating the secondary manipulator based on the at least one recorded primary joint position;
wherein the primary manipulator is controlled to adopt the at least one calibration state based on the load data; and/or
wherein the calibration of the secondary manipulator is additionally made based on the load data.

2. The method according to claim 1, wherein the method comprises controlling the primary manipulator to adopt a plurality of calibration states, each calibration state being a unique manipulator pose of the primary manipulator.

3. The method according to claim 2, wherein the primary manipulator is controlled to adopt the at least one calibration state based on the load data, and wherein the load, as measured by the load sensor, is minimized or locally minimized in each manipulator pose.

4. The method according to claim 2, wherein the method further comprises moving the primary manipulator to a plurality of calibration states while moving the secondary manipulator by the primary manipulator by means of lead-through.

5. The method according to claim 1, wherein the load sensor is configured to provide load data indicative of forces and/or torques.

6. A control system for calibrating a manipulator of an industrial robot, the control system comprising at least one data processing device and at least one memory having at least one computer program stored thereon, the at least one computer program including a program code which, when executed by the at least one data processing device, causes the at least one data processing device to perform the steps of:
receiving load data from a load sensor indicative of loads, the load sensor being positioned between a primary mounting interface of a primary manipulator having one or more primary joints and a secondary mounting interface of a secondary manipulator having one or more secondary joints, where the primary mounting interface is substantially rigidly connected to the secondary mounting interface;
controlling the primary manipulator to adopt at least one calibration state;
for each calibration state, recording a primary joint position of at least one primary joint; and
calibrating the secondary manipulator based on the at least one recorded primary joint position;
wherein the primary manipulator is controlled to adopt the at least one calibration state based on the load data; and/or
wherein the calibration of the secondary manipulator is additionally made based on the load data.

7. The control system according to claim 6, wherein the at least one computer program comprises program code which, when executed by the at least one data processing device, causes the at least one data processing device to perform the steps of:
controlling the primary manipulator to adopt a plurality of calibration states, each calibration state being a unique manipulator pose of the primary manipulator.

8. The control system according to claim 7, wherein the at least one computer program comprises program code which, when executed by the at least one data processing device causes the at least one data processing device to perform the step of controlling the primary manipulator to adopt the at least one calibration state based on the load data; and wherein the load, as measured by the load sensor, is minimized or locally minimized in each manipulator pose.

9. The control system according to claim 7, wherein the at least one computer program comprises program code which, when executed by the at least one data processing device, causes the at least one data processing device to perform the steps of:
controlling the secondary manipulator in a lead-through mode; and
controlling the primary manipulator to move to a plurality of calibration states while controlling the secondary manipulator in the lead-through mode.

10. A robot system comprising a primary manipulator, a secondary manipulator, a load sensor, a control system, and at least one computer program including a program code which, when executed, controls the primary manipulator to adopt a plurality of calibration states, each calibration state being a unique manipulator pose of the primary manipulator.

11. The robot system according to claim 10, further comprising a connection member including the load sensor and configured to be rigidly connected to each of the primary mounting interface and the secondary mounting interface.

12. The robot system according to claim 10, wherein the load sensor is configured to provide load data indicative of forces and/or torques.

13. The method according to claim 3, wherein the method further comprises moving the primary manipulator to a plurality of calibration states while moving the secondary manipulator by the primary manipulator by means of lead-through.

14. The method according to claim 2, wherein the load sensor is configured to provide load data indicative of forces and/or torques.

15. The control system according to claim 8, wherein the at least one computer program comprises program code which, when executed by the at least one data processing device, causes the at least one data processing device to perform the steps of:
controlling the secondary manipulator in a lead-through mode; and
controlling the primary manipulator to move to a plurality of calibration states while controlling the secondary manipulator in the lead-through mode.

16. The robot system according to claim 11, wherein the load sensor is configured to provide load data indicative of forces and/or torques.
